(19) United States
(12) Patent Application Publication
(10) Pub. No.: US 2018/0025359 A1
(43) Pub. Date: Jan. 25, 2018

(54) CUSTOMER JOURNEY OPTIMIZED PRE-FETCHING

(71) Applicant: SugarCRM Inc., Cupertino, CA (US)

(72) Inventors: Matt Marum, Raleigh, NC (US); Henry Rogers, Raleigh, NC (US)

(21) Appl. No.: 15/214,442

(22) Filed: Jul. 19, 2016

(51) Int. Cl. G06Q 30/00; G06Q 30/06; G06Q 10/06

(52) U.S. Cl. CPC G06Q 30/01; G06Q 10/0633; G06Q 10/067; G06Q 30/0611

(57) ABSTRACT

Embodiments of the present invention provide a method, system and computer program product for customer journey optimized data pre-fetching. In a method of invention, different stages of a customer journey in a customer journey model are defined for customers of a CRM application. As well, a mapping is created in the CRM application between each of the stages of the customer journey in the customer journey model and a corresponding selection of resources of the CRM application. Thereafter, a retrieval of a customer related record for a particular one of the customers is detected and in response, a particular one of the stages of the customer journey is identified that corresponds to the particular one of the customers, a corresponding selection of resources is determined from the mapping for the identified particular one of the stages, and the selection of resources is pre-fetched.

### BACKGROUND OF THE INVENTION

### Field of the Invention

The present invention relates to customer relationship management (CRM) and more particularly to customer journey mapping in a CRM application.

### Description of the Related Art

In the realm of CRM, the customer journey is one of the most important tools for understanding the business-customer relationship. Essentially, the customer journey involves identifying every possible way in which a customer might interact with the business, from the prospective customer browsing the Internet and encountering the Web site of the business, to the process by which the customer purchases a product or service from the business. The diagram referred to as the “customer journey map” remains the most common way to depict the customer journey. The customer journey map generally provides visual that depicts the stages through which each customer passes while interacting with the business. Using data-driven research, then, the business may create a customer journey map to help identify gaps in the customer experience, thus making it easier to establish CRM solutions for the business.

Customer journey maps generally represent three main aspects of the customer journey from the perspective of the customer: customer sentiment, business goals, and all possible touch points between the customer and the business. With the knowledge of customer sentiment and business goals, the business may address each touch point of communication through which customers can connect with the company. Touch points often consist of social media platforms, search engines, links on external websites, and telephones. In an efficient customer journey map, all possible paths of communication are covered, thus encapsulating every way a customer could be in contact with the business.

The diagram presented by the customer journey map generally is a “current state map”. This type of customer journey map illustrates what customers think and feel as the customers interact with the business in its current form. While identifying pain points and customer gaps, the current state map helps employees develop empathy for customers while aligning the company around the customers' point of view. If the goal of the business to envision the future customer experience, a future state map is the most effective form of the customer journey map. This differs from the current state map in that it identifies opportunities for innovation while allowing the company to plan the usage of a future product or service. If the current state map reflects an inefficient system, a future state blueprint can be used as a solution. This hypothetical customer journey map helps plan for a future system that must be in place to support the clients' intended experience.

Tools to assist with the production of customer journey maps currently exist in downloadable form on the Internet. Generally, customer journey maps are offered as downloadable templates that are easy to edit and augment, thus simplifying the creation of the customized customer journey maps. More advanced downloadable tools include full blown applications that allow end users to create customer journey maps. In CRM, customer journey maps are an effective tool to help the business grow. Through data-driven research, customer journey maps help identify pain points in the customer experience and thus the best way to find a solution. By forcing the company to focus on the customers and their sentiments, customer journey maps help businesses cater to their clientele more accurately, resulting in a more efficiently run business.

### BRIEF SUMMARY OF THE INVENTION

Embodiments of the present invention address deficiencies of the art in respect to integrating the customer journey integration into CRM and provide a novel and non-obvious method, system and computer program product for customer journey optimized data pre-fetching. In a method embodiment of the invention, different stages of a customer journey in a customer journey model are defined for customers of a CRM application executing in memory of a computer. As well, a mapping is created in the CRM application between each of the stages of the customer journey in the customer journey model and a corresponding selection of resources of the CRM application. Thereafter, a retrieval of a customer related record for a particular one of the customers is detected and in response, a particular one of the stages of the customer journey is identified that corresponds to the particular one of the customers, a corresponding selection of resources is determined from the mapping for the identified particular one of the stages, and the selection of resources is pre-fetched into the memory of the computer.

In one aspect of the embodiment, a user interface action performed by a customer is detected in a Web site that is separate from the CRM application. Thereafter, the customer performing the user interface action is identified a contemporaneous one of the stages of the customer journey determined for the customer performing the user interface action based upon a context of a Web page in which the user interface action is performed. Finally, responsive to the determination of the contemporaneous one of the stages of the customer journey for the customer performing the user interface action, a corresponding selection of resources is determined from the mapping for the identified particular one of the stages, and the selection of resources are pre-fetched into the memory of the computer through the CRM application.

In another embodiment of the invention, a CRM application is configured for customer journey optimized data pre-fetching. The system includes a host computing platform with one or more computers each with memory and at least one processor. The system also includes a CRM application executing in the memory of the host computing platform. Finally, the system includes a CRM data prefetching module coupled to the CRM application. The module includes program code enabled upon execution in the memory to define for customers of the CRM application different stages of a customer journey in a customer journey model, to create a mapping in the CRM application between each of the stages of the customer journey in the customer journey model and a corresponding selection of resources of the CRM application, to detect a retrieval of a customer related record for a particular one of the customers and to respond to the detection of the retrieval of the customer related record by identifying a particular one of the stages of the customer journey corresponding to the particular one of the customers, determining a corresponding selection of resources from the mapping for the identified particular one of the stages, and pre-fetching the selection of resources into the memory of the computer.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for customer journey optimized data pre-fetching in a CRM application;

FIG. 2 is a schematic illustration of a CRM data processing system configured for customer journey optimized data pre-fetching; and,

FIG. 3 is a flow chart illustrating a process for customer journey optimized data pre-fetching in a CRM application.

### DETAILED DESCRIPTION OF THE INVENTION

Embodiments of the invention provide for customer journey optimized data pre-fetching in a CRM application. In accordance with an embodiment of the invention, different stages of a customer journey are defined for all customers of the CRM application. As well, a mapping is defined between each of the stages of the customer journey and a corresponding selection of resources of the CRM application, such as quotations, opportunities, documents, electronic messages and the like. Thereafter, in response to the retrieval of a customer related record for a customer in the CRM application, a stage of the customer journey for the customer is identified and the mapping consulted in order to select a mapped selection of the resources in the CRM application and the resources in the selection are pre-fetched into memory. In this way, the CRM application will have anticipated the loading into memory of relevant CRM application resources.

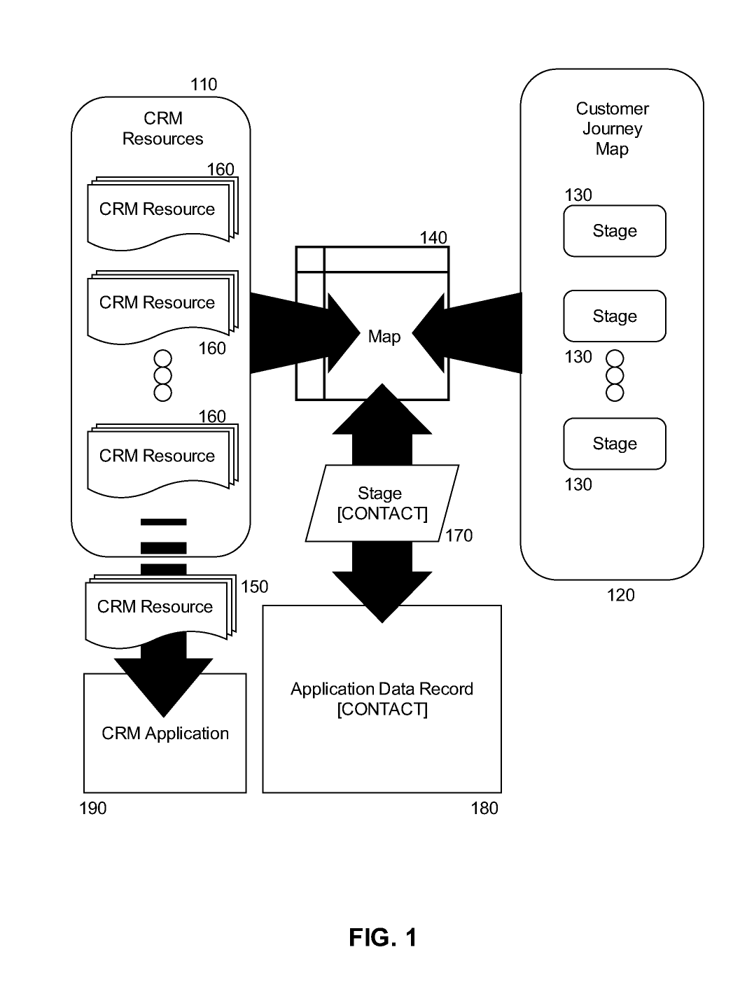

In further illustration, FIG. 1 pictorially shows a process for customer journey optimized data pre-fetching in a CRM application. As shown in FIG. 1, a customer journey map 120 of different stages 130 of a customer journey is defined for the customers of a CRM application 190. Thereafter, a mapping 140 is established mapping the different stages 130 to different selections 160 of CRM resources 160 of the CRM application 190. In this regard, each of the different selections 160 is mapped in the map 140 to correspond to one of the stages 130 of the customer journey map 120. Subsequently, a loading of a record 180 is detected. The loading of the record 180 may be detected in a Web browser in the context of a Web page, or within a user interface of the CRM application 190 itself.

Upon detecting a loading of the record 180, a contact is identified as corresponding to the loaded record. For instance, if a Web page, meta-data of the Web page may be parsed to identify a textual identifier of the contact. Alternatively, if a user interface to the CRM application 190, the contact for the loaded record can be directly identified from the CRM application 190. In either case, a current stage 170 amongst the stages 130 of the customer journey 120 can be determined for the identified contact. In the case of the record appearing in the user interface of the CRM application 190, the current stage 170 can be directly determined by query to the CRM application 190. However, in the event the loaded record appears in a Web page in a Web browser, a past pattern of Web browser interactions by the contact can be matched to a known pattern indicative of the current stage 170.

In either circumstance, once the current stage 170 is determined for the contact, the mapping 140 is queried with the current stage 170 to identify a corresponding one 150 of the selections 160 of the CRM resources 110. Finally, the corresponding one 150 of the selections 160 of the CRM resources 110 are pre-fetched in the CRM application 190 and displayed in a user interface of the CRM application 190.

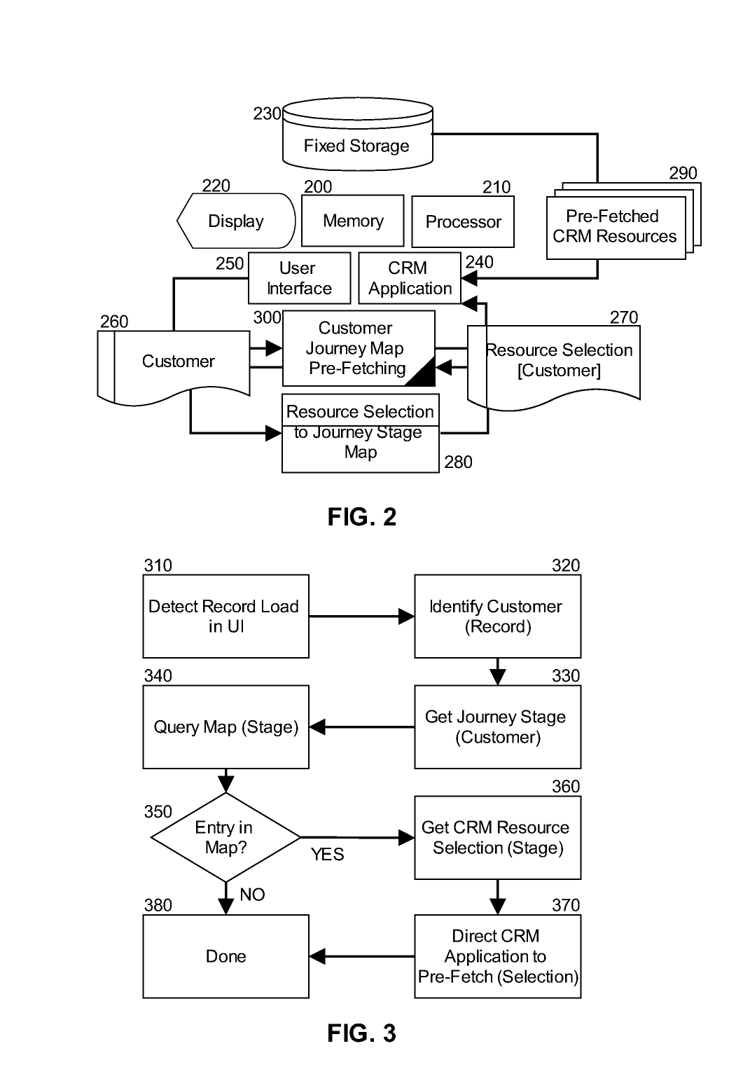

The process described in connection with FIG. 1 may be implemented in a CRM data processing system. In yet further illustration, FIG. 2 schematically shows a CRM data processing system configured for customer journey optimized data pre-fetching. The system includes a host computing platform that includes one or more computers (only a single computer shown for ease of illustration) each with memory 200, at least one processor 210 and a display 220. Fixed storage 230 also is provided. A CRM application 240 executes in the memory 200 by the processor 210 and generates a user interface 250 in the display 220 through which an end user interacts with the CRM application 240.

Of note, customer journey map pre-fetching module 300 is coupled to the CRM application 240. The module 300 includes program code enabled upon execution in the memory 200 by the processor 210 to detect a loading of a record in the user interface 250 and to identify a customer 260 corresponding to the loaded record. Thereafter, the program code determines a stage of a customer journey for the customer 260. The program code then queries a resource selection to journey stage mapping 280 with the determined stage so as to locate a corresponding selection of CRM resources 270. For instance, the selection of CRM resources 270 may include one or more quotations, opportunities, documents, or electronic messages corresponding to the customer 260 and stored in the fixed storage 230 in connection with the CRM application 240. Finally, the program code directs the CRM application 240 to pre-fetch the CRM resources 290 of the corresponding selection of CRM resources 270 from the fixed storage 230.

In even yet further illustration of the operation of the customer journey map pre-fetching module 300, FIG. 3 is a flow chart illustrating a process for customer journey optimized data pre-fetching in a CRM application. Beginning in block 310, a record load is detected in a user interface such as a screen of a CRM application or in a Web browser. In block 320, a customer associated with the loaded record is identified. For instance, if the record is loaded in a screen of the CRM application, the associated customer is determined directly from the CRM application. But, if the record is loaded in a Web page of a Web browser, the Web browser may be queried to identify the customer. In either instance, a stage of a customer journey for the customer is then determined in block 330.

In block 340, a mapping is consulted to identify a selection of resources corresponding to the determined stage of the customer journey for the identified customer. In decision block 350 if an entry is found in the mapping for the determined stage, in block 360 the selection of CRM resources mapped to the determined stage are selected and in block 370 the CRM application is directed to pre-fetch the resources of the selection. Finally, in block 380 the process ends.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A customer journey optimized data pre-fetching method comprising:
defining for customers of a customer relationship management (CRM) application executing in memory of a computer, different stages of a customer journey in a customer journey model;
creating a mapping in the CRM application between each of the stages of the customer journey in the customer journey model and a corresponding selection of resources of the CRM application;
detecting a retrieval of a customer related record for a particular one of the customers; and,
responsive to the detection of the retrieval of the customer related record, identifying a particular one of the stages of the customer journey corresponding to the particular one of the customers, determining a corresponding selection of resources from the mapping for the identified particular one of the stages, and pre-fetching the selection of resources into the memory of the computer.

2. The method of claim 1, wherein the resources include messages addressed to or transmitted by different ones of the customers.

3. The method of claim 1, wherein the resources include sales quotations generated on behalf of different ones of the customers.

4. The method of claim 1, wherein the resources include opportunity records stored in the CRM application in connection with different ones of the customers.

5. The method of claim 1, wherein the mapping is stored as part of the customer journey model.

6. The method of claim 1, further comprising:
detecting a user interface action performed by a customer in a Web site that is separate from the CRM application;
identifying the customer performing the user interface action;
determining a contemporaneous one of the stages of the customer journey for the customer performing the user interface action based upon a context of a Web page in which the user interface action is performed; and,
responsive to the determination of the contemporaneous one of the stages of the customer journey for the customer performing the user interface action, determining a corresponding selection of resources from the mapping for the identified particular one of the stages, and pre-fetching the selection of resources into the memory of the computer through the CRM application.

7. A customer relationship management (CRM) application configured for customer journey optimized data pre-fetching, the system comprising:
a host computing platform comprising one or more computers each with memory and at least one processor;
a CRM application executing in the memory of the host computing platform; and
a CRM data prefetching module coupled to the CRM application, the module comprising program code enabled upon execution in the memory to define for customers of the CRM application different stages of a customer journey in a customer journey model, to create a mapping in the CRM application between each of the stages of the customer journey in the customer journey model and a corresponding selection of resources of the CRM application, to detect a retrieval of a customer related record for a particular one of the customers and to respond to the detection of the retrieval of the customer related record by identifying a particular one of the stages of the customer journey corresponding to the particular one of the customers, determining a corresponding selection of resources from the mapping for the identified particular one of the stages, and pre-fetching the selection of resources into the memory of the computer.

8. The system of claim 7, wherein the resources include messages addressed to or transmitted by different ones of the customers.

9. The system of claim 7, wherein the resources include sales quotations generated on behalf of different ones of the customers.

10. The system of claim 7, wherein the resources include opportunity records stored in the CRM application in connection with different ones of the customers.

11. The system of claim 7, wherein the mapping is stored as part of the customer journey model.

12. The system of claim 7, wherein the program code of the module is further enabled to detect a user interface action performed by a customer in a Web site that is separate from the CRM application, identify the customer performing the user interface action, determine a contemporaneous one of the stages of the customer journey for the customer performing the user interface action based upon a context of a Web page in which the user interface action is performed and respond to the determination of the contemporaneous one of the stages of the customer journey for the customer performing the user interface action by determining a corresponding selection of resources from the mapping for the identified particular one of the stages and pre-fetching the selection of resources into the memory of the computer through the CRM application.

13. A computer program product for customer journey optimized data pre-fetching, the computer program product comprising a computer readable storage medium having program instructions embodied therewith, the program instructions executable by a device to cause the device to perform a method comprising:
defining for customers of a customer relationship management (CRM) application executing in memory of a computer, different stages of a customer journey in a customer journey model;
creating a mapping in the CRM application between each of the stages of the customer journey in the customer journey model and a corresponding selection of resources of the CRM application;
detecting a retrieval of a customer related record for a particular one of the customers; and,
responsive to the detection of the retrieval of the customer related record, identifying a particular one of the stages of the customer journey corresponding to the particular one of the customers, determining a corresponding selection of resources from the mapping for the identified particular one of the stages, and pre-fetching the selection of resources into the memory of the computer.

14. The computer program product of claim 13, wherein the resources include messages addressed to or transmitted by different ones of the customers.

15. The computer program product of claim 13, wherein the resources include sales quotations generated on behalf of different ones of the customers.

16. The computer program product of claim 13, wherein the resources include opportunity records stored in the CRM application in connection with different ones of the customers.

17. The computer program product of claim 13, wherein the mapping is stored as part of the customer journey model.

18. The computer program product of claim 13, wherein the method further includes:
detecting a user interface action performed by a customer in a Web site that is separate from the CRM application;
identifying the customer performing the user interface action;
determining a contemporaneous one of the stages of the customer journey for the customer performing the user interface action based upon a context of a Web page in which the user interface action is performed; and,
responsive to the determination of the contemporaneous one of the stages of the customer journey for the customer performing the user interface action, determining a corresponding selection of resources from the mapping for the identified particular one of the stages, and pre-fetching the selection of resources into the memory of the computer through the CRM application.
